(19) United States
(12) Patent Application Publication
(10) Pub. No.: US 2016/0052329 A1
(43) Pub. Date: Feb. 25, 2016

(54) MOBILE, RELEASABLY ATTACHABLE, WHITE-BOARD

(71) Applicant: American Covers, Inc., Draper, UT (US)

(72) Inventors: Bryce Haymond, Pleasant Grove, UT (US); Jason Fogg, Draper, UT (US)

(21) Appl. No.: 14/463,300

(22) Filed: Aug. 19, 2014

(51) Int. Cl. B43L 1/00

(52) U.S. Cl. CPC B43L 1/002

(57) ABSTRACT

A mobile, releasably attachable, white-board comprises a pad formed of polyurethane having a composition of polymer and catalyst to impart a tacky character to at least the inner surface so that the inner surface is capable of removable tacky attachment to a support surface without additional adhesive. A dry-erase sheet is affixed to the pad.

### BACKGROUND

1. Field of the Invention

The present invention relates generally to a portable or mobile, releasably attachable white-board or dry-erase board.

2. Related Art Physical notes can be left for a person by using self-adhesive paper squares (Post-It® notes), or taped paper. In addition, magnetic white-boards have been developed.

### SUMMARY OF THE INVENTION

It has been recognized that it would be advantageous to develop a mobile or portable, releasably attachable, white-board or dry-erase board that can erasably receive notes thereon, and that can be removably disposed on numerous different support surfaces.

The invention provides a mobile, releasably attachable, white-board device, comprising a pad having opposite inner and outer surfaces. The pad is formed of polyurethane having a composition of polymer and catalyst to impart a tacky character to at least the inner surface so that the inner surface is capable of removable tacky attachment to a support surface without additional adhesive. A primary indentation is in the outer surface of the pad and is circumscribed by a perimeter rib. A dry-erase sheet is affixed to the pad in the primary indentation of the outer surface and is circumscribed by the perimeter rib. An outermost surface of the dry-erase sheet is substantially flush with an outermost surface of the perimeter rib. The primary indentation and the dry-erase sheet occupy a majority of the surface area of the pad. A dry-erase marker is removable coupled to the pad, and is removable from the pad to write on the dry-erase sheet.

In addition, the invention presents a mobile, releasably attachable, white-board device, comprising a pad having opposite inner and outer surfaces. The pad is formed of polyurethane having a composition of polymer and catalyst to impart a tacky character to at least the inner surface so that the inner surface is capable of removable tacky attachment to a support surface without additional adhesive. A dry-erase sheet is affixed to the pad.

Furthermore, the invention presents a mobile, releasably attachable, white-board device, comprising a pad having opposite inner and outer surfaces. The pad is formed of polyurethane having a composition of polymer and catalyst to impart a tacky character to at least the inner surface so that the inner surface is capable of removable tacky attachment to a support surface without additional adhesive. A primary indentation is in the outer surface of the pad and is circumscribed by a perimeter rib. A dry-erase sheet is affixed to the pad in the primary indentation of the outer surface and is circumscribed by the perimeter rib. An outermost surface of the dry-erase sheet is substantially flush with an outermost surface of the perimeter rib. The primary indentation and the dry-erase sheet occupy a majority of the surface area of the pad. A dry-erase marker is removable coupled to the pad, and is removable from the pad to write on the dry-erase sheet. A pair of raised ribs extends from the outer surface of the pad, and defines a channel therebetween. The dry-erase marker is removable disposed in the channel. The dry-erase marker has a diameter greater than a width of the channel. The pair of raised ribs is flexible and resilient to grip the marker when disposed therein. A secondary recess is in the outer surface of the pad, and is located laterally adjacent to the primary indentation. A polyurethane dome is affixed in the secondary recess.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a front view of a mobile, releasably attachable, white-board device in accordance with an embodiment of the present invention;

FIG. 2 is a side view of the white-board device of FIG. 1, shown removably attached to a support surface, and a white-board marker removable from a pad;

FIG. 3 is a cross-sectional side view of the white-board device of FIG. 1, taken along line 3 of FIG. 1;

FIG. 4 is a top view of the white-board device of FIG. 1;

FIG. 5 is a front view of the white-board device of FIG. 1, shown with the white-board marker removed from the pad;

FIG. 6 is a back view of the white-board device of FIG. 1; and

FIG. 7 is a detailed cross-sectional view of the white-board device, and a polyurethane dome thereon.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

The terms “business”, “company” are used broadly and interchangeably herein to refer to an organization that provides a product or a service. The business, company or organization can have a name, logo, slogan, trademark, service mark, etc. that is capable of identifying and/or distinguishing the business or company, or product or service, or both, or can otherwise be utilized to market, promote, and/or brand the business or company, or product or service, or both.

### Description

The present invention provides a mobile or portable, releasably attachable, white-board or dry-erase board that can erasably receive notes thereon, and that can be removably disposed on numerous different support surfaces. The board can be removably attached to one surface, and removed and re-attached to another surface. Thus, the board can be placed and re-placed as desired. The board can utilize a tacky surface, such as that created by a polyurethane, to releasably attach to the surface, without the use of adhesive, fasteners, magnets, etc. The tacky attachment or grip can be described as a special or mechanical adhesion, as opposed to a chemical adhesive, mechanical fastener, or a magnetic fastener. The board can be used on a variety and plurality of surfaces, and sequentially moved from surface to surface, such as in a vehicle, an office, home, dashboard, desktop, cabinet, refrigerator, window, wall, door, etc.

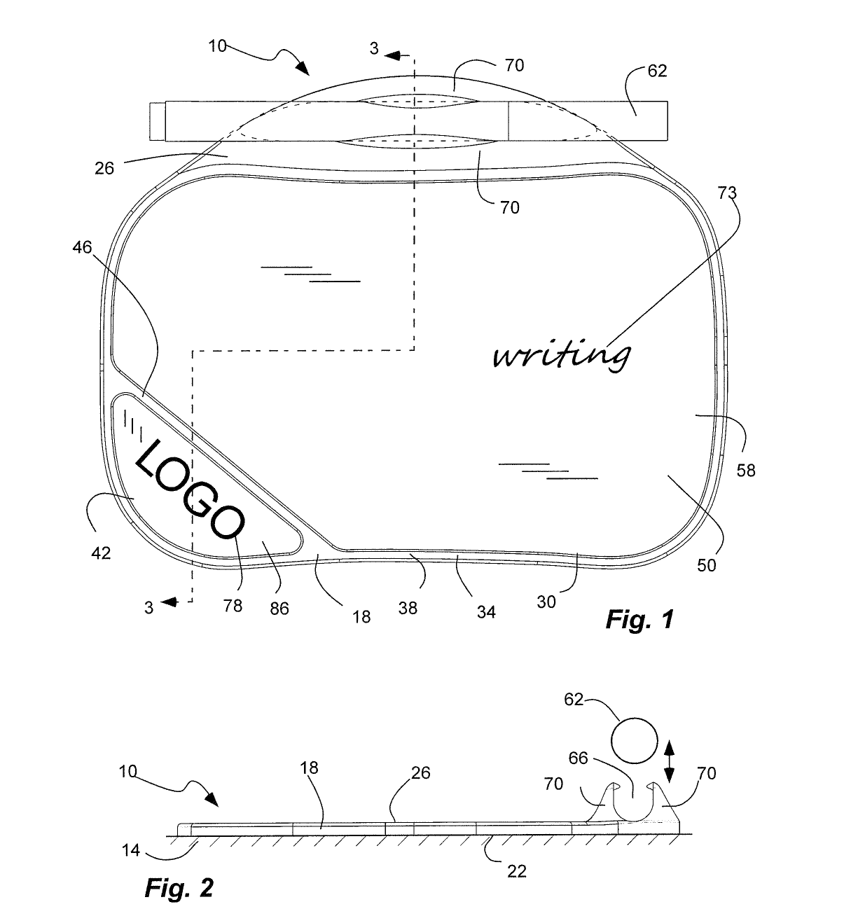

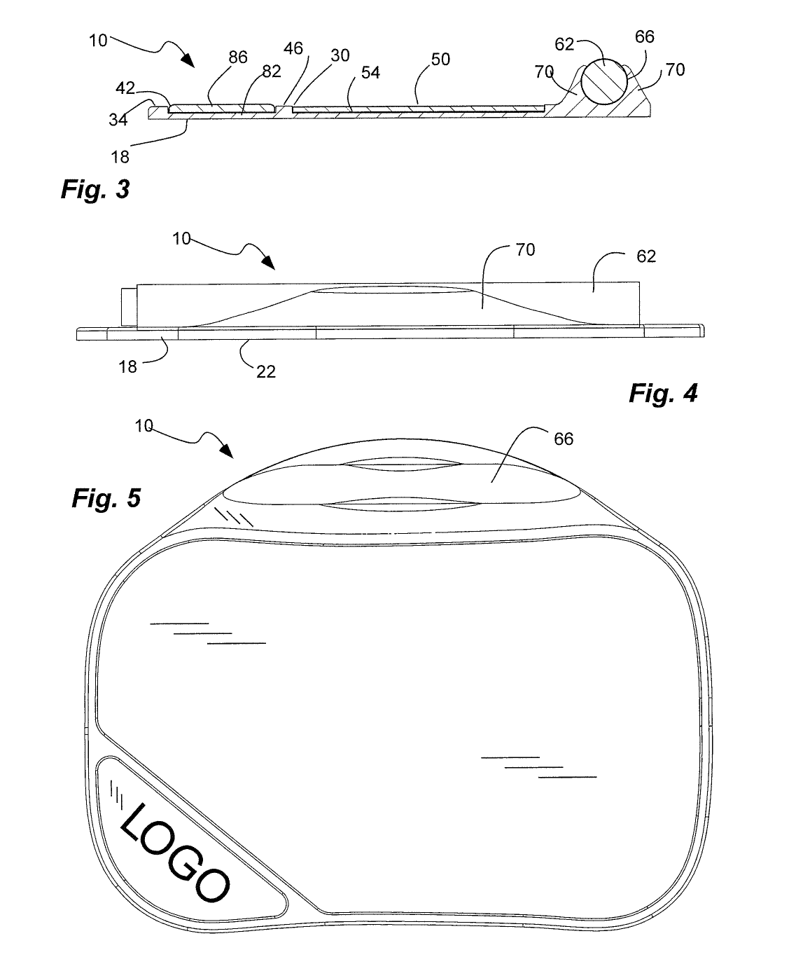

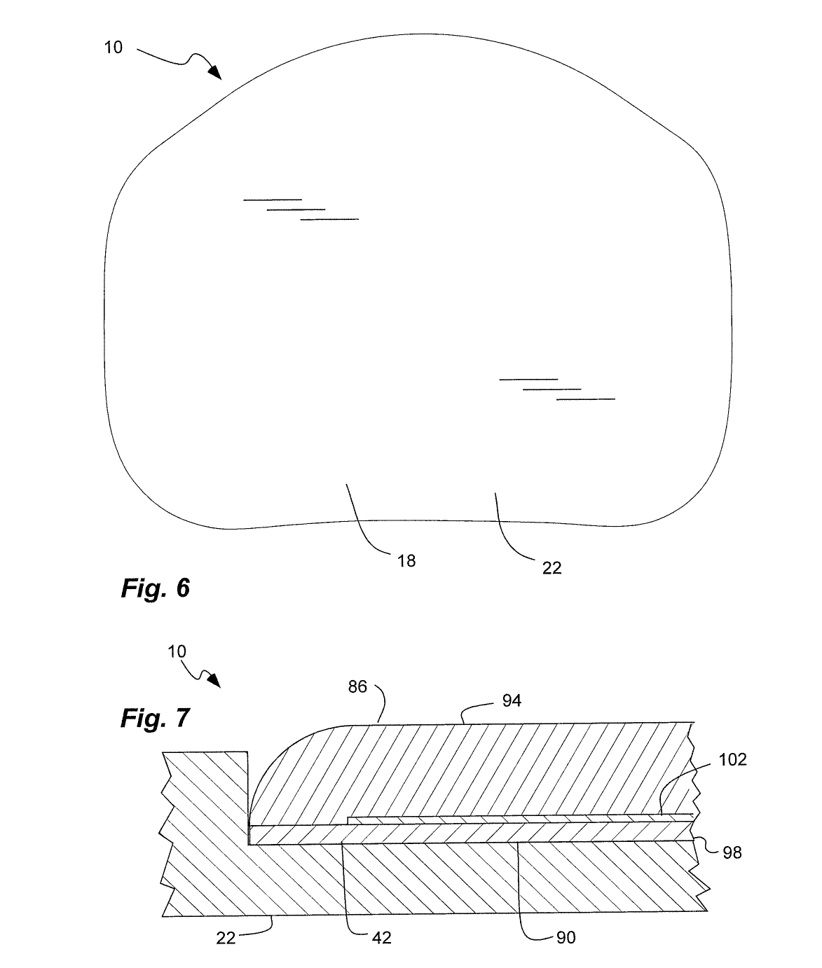

As illustrated in FIGS. 1-7, a white-board or dry-erase board, indicated generally at 10, in an example implementation in accordance with the invention is shown for being movable between a variety of different support surfaces, indicated at 14. The board or device comprises a pad 18 having opposite inner 22 and outer 26 surfaces. The inner surface can face and attached to the support surface 14, while the outer surface 26 can face outwardly from the support surface. The pad 18 can be formed of or can comprise a polyurethane having a composition of polymer and catalyst to impart a tacky character to at least the inner surface 22, so that the inner surface is capable of removable tacky attachment to the support surface 14 without additional adhesive. In one aspect, the polyurethane of the pad 18 can be formed of polymer and catalyst in a ratio of between 1:0.3 to 1:0.4. In another aspect, the polyurethane of the pad 18 can be formed of polymer and catalyst in a ratio of 1:0.36. The pad can be flexible, and can conform to the support surface, or curve thereof Similarly, in one aspect, the entire board of device can be flexible.

The pad 18 can have a primary indentation 30 in the outer surface 26. The primary indentation 30 can be circumscribed by a perimeter rib 34 that can extend entirely or at least partially around the indentation 30. The perimeter rib can extend from the pad, and can have an outermost surface 38. The primary indentation 30 can occupy a majority of the surface area of the pad 18 or the outer surface 26. In addition, the pad 18 can have a secondary recess 42 in the outer surface 26. The secondary recess 42 can be located laterally adjacent or proximal to the primary indentation 30. In one aspect, the secondary recess 42 and the primary indentation 30 can be separated from one another by an interior rib 46 that can extend between and be continuous with the perimeter rib 34. The secondary recess 42 can occupy a minority of the surface are of the pad 18 or the outer surface 26.

The pad 18 can also have a dry-erase sheet 50 affixed to the pad 18 and disposed in the primary indentation 30 of the outer surface 26, and circumscribed by the perimeter rib 34. Thus, the pad can carry the dry-erase sheet and removably couple the dry-erase sheet to a support surface. The dry-erase sheet 50 can be permanently attached to the pad, or an outward facing surface 54 of the primary indentation 30. The dry-erase sheet can have an outermost surface 58 that can removably receive a dry-erase substance from a dry-erase marker, as is known in the art. The outermost surface 58 of the dry-erase sheet 50 can provide and can define a writing surface. The outermost surface 58 of the dry-erase sheet 50 can be substantially flush with an outermost surface 38 of the perimeter rib 34, and the interior rib 46. Thus, the perimeter rib 34, and the inner rib 46, can cover a perimeter edge of the dry-erase sheet 50, and provide a finished surface. The dry-erase sheet 50 can fill the surface area or open area of the primary indentation 30. Thus, the dry-erase sheet 50, along with the primary indentation 30, can occupy a majority of the surface area of the pad 18. Thus, the size of the pad is efficiently used, and the writing surface of the dry-erase sheet is maximized.

A dry-erase marker 62 can be removable coupled to the pad 18, and can be removable from the pad to write on the dry-erase sheet 50. The dry-erase marker can contain a dry-erase substance or ink, as is known in the art. In one aspect, the dry-erase marker 62 can be removably coupled to the pad by a channel 66 into which the marker can be removably disposed, and inserted and removed, and held by a friction fit. In one aspect, a pair of raised ribs 70 can extend from the outer surface 26 of the pad 18, and can define the channel 66 therebetween. The pair of raised ribs 70 can be formed integrally with the pad, and can be flexible and resilient, to flex to grip the marker 62 when disposed therein. In addition, the dry-erase marker 62 can have a diameter greater than a width of the channel 66. Thus, inserting the marker into the channel pushes the pair of ribs outwardly; while the resilience of the pair of rigs grips the marker therebetween.

A method for using the board or device 10 comprises: placing the pad 18 against a first support surface 14 with the inner surface 22 of the pad removably attached to the first support surface; removing the dry-erase marker 62 from the pad; writing on the dry-erase sheet 50 with the dry-erase marker, defining writing (indicated at 74); re-coupling the dry-erase marker 62 to the pad 18 (such as by disposing the marker in the channel 66 and between the pair of ribs 70; removing the pad 18 from the first support surface 14; placing the pad 18 against a second support surface (also indicated by 14), different than the first support surface, with the inner surface of the pad removably attached to the second support surface; and erasing the writing 74 on the dry-erase sheet 50. All or some of the steps described above can be performed. In addition, the steps described above can be performed in the order listed, or in any order.

The board or device 10 can have a size to facilitate ready or easy mobility. For example, the board or device can have a size less than 8.5×11 inches in one aspect, less than 6×8 inches in another aspect, and less than 5×6 inches in another aspect. In addition, the pad 18 can have a thickness between the opposite inner 22 and outer 26 surfaces of less than 6 mm in one aspect, less than 5 mm in another aspect, and less than 4 mm in another aspect.

The board or device 10 can also include indicia 78 indicative of or representing a business, a product, or both. Thus, the device 10 can be utilized as a promotional device, and distributed to potential customers, to place the indicia in ready view of users. Thus, the indicia can include a logo or picture. In another aspect, the indicia can include instructions for use, warnings regarding use, etc. The indicia 78 can be disposed on an outward facing surface 82 of the secondary recess 42. In one aspect, the indicia 78 can be formed on the pad, or in the secondary recess, by screen printing, pad printing, etc. In another aspect, the indicia can be formed in the pad itself in three-dimensions.

In another aspect, a polyurethane dome 86 affixed in the secondary recess. The polyurethane dome 86 can include the indicia. In addition, the polyurethane dome can have tacky properties to which items can be removably secured. Thus, the board or device 10 can provide both a writing surface to receive notes, and a tacky surface to receive items. The items can include, paper notes, paper receipts, keys, etc.

The polyurethane dome 86 can be adhered to the pad 18 or secondary recess 42 or outward facing surface 82 thereof by an adhesive film 90. The polyurethane dome can be stiffer than the pad. Thus, the polyurethane dome can provide support and a degree of rigidity to the pad to maintain a flat or planer layer. The dome can have a broad, flat shape with an outfacing surface 94 parallel with the pad or outward facing surface 82 of the secondary recess, and surrounded by a radius perimeter. A majority, or essentially all, of the outward facing surface 94 can be continuous and smooth and parallel with the pad or outward facing surface of the secondary recess. In addition, the outward facing surface 94 can be flat or substantially flat. Furthermore, the outward facing surface 94 can be surrounded by a radius perimeter. Thus, the perimeter of the outward facing surface curves toward the pad. In one aspect, all of the outward facing surface can be flat and smooth and continuous between the radiused perimeter. Thus, the dome 86 can resist snagging on other objects. The outfacing surface 94 can be tacky, and can cling to an item by specific or mechanical adhesion. The tackiness of the outward surface can be obtained through various factors, which can include material, hardness/softness, and coefficient of friction. As described above, the dome can be formed of polyurethane. The polyurethane can be formed by combining a polyol with a catalyst or hardener. In one aspect, the ratio of polyol to catalyst can be between 0.85 to 0.95, and about 0.90 in another aspect, so that there is more polyol than catalyst. In another aspect, the ratio of polyol to catalyst can be between 0.63 to 0.85 in one aspect, and between 0.63 to 0.75 in another aspect, so that there is more polyol than catalyst. Typical polyurethane is obtained by mixing polyol and catalyst in a 1:1 ratio. In addition, in one aspect, the outward facing surface 94 or dome 86 can have a hardness between 10 and 35 Shore D. In another aspect, the outward facing surface 94 or dome 86 can have a hardness between 12 and 21 Shore D. In another aspect, the outward facing surface 94 or dome 86 can have a hardness between 12 and 18 Shore D. Other non-tacky stickers or decals typically can have a hardness of 60 Shore D or harder. Furthermore, the outward facing surface 94 can have a coefficient of friction of between 0.3 and 0.1 in accordance with ASTM D 1894.

The polyurethane dome 86 can include an adhesive film 90 adhered to the chamois pad 18. The adhesive can be selected to provide sufficient adhesion between the polyurethane dome and the pad. The adhesive film can use a chemical adhesive that adheres to the pad. In addition, the adhesive and/or the adhesive film can be substantially transparent, or at least translucent. The adhesive film 90 can be disposed on a substrate 98. The substrate 98 can also be a film. In one aspect, the substrate can be substantially non-absorbent. The substrate can provide a surface, such as an upper surface opposite the adhesive that can be printable. In addition, the substrate can be substantially transparent, or at least translucent. The substrate can be a printed 3M Graphics Vinyl. Alternatively, the substrate can be a polyester film. The substrate can be any laminated (non-porous) substrate, including: PP, PVC, PET, ABS, polyester, regular sticker paper, vinyl, or tin metal (foil). Alternatively, the substrate can be other films with other characteristics, such as reflective, metal shine, textured, etc. A strength of the adhesive bond between the adhesive film and the pad can be greater than a tacky cling between the outward facing surface 94 and the item(s). Thus, the dome remains on the pad while the item is removed from the dome.

Furthermore, the polyurethane dome 86 can be substantially transparent, or at least translucent. A graphic layer 102 can be disposed behind the dome 86 and visible through the dome. Thus, the graphic layer 102 can be disposed between the pad 18 (or adhesive film) and the dome 86, or between the substrate 98 and the dome 86. The graphic layer can include ink disposed on or printed on the substrate. For example, the graphic layer can be an aqueous based inkjet ink. The graphic layer can include the indicia 78. The graphic layer can include indicia that can be or can include letters, symbols, figures, pictures, logos, art, corporate messages, slogans, bi-lines, icons, etc. that are associated with or that form a representation of a business, company or organization or the like, or a product, service or the like, or both. Furthermore, the graphic layer can be or can include other inclusions, as described in greater detail below. The graphic layer 102 can be visible through the dome 86. Thus, the dome can protect the indicia. The graphic layer and/or inclusion can be smaller or can have a smaller size than the substrate and dome such that the graphic layer and inclusion are surrounded by a perimeter of the dome and substrate.

As discussed above, the dome or outward facing surface can have a radius perimeter. The dome can be made by pouring the polyurethane material on top of the substrate and graphic layer to form the dome. Thus, the radius perimeter is obtained by individual pouring each pad or dome, without stamping or cutting the pads from a continuous layer. The graphic layer can be printed on the substrate having the adhesive film opposite the graphic layer. The graphic layer can be a discrete graphic contained within the dome, as opposed to a continuous graphic.

As indicated above, the graphic layer can be or can include an inclusion. The inclusions can be embedded in the dome. For example, the graphic layer can be an etched metallic layer. The metallic layer can be etched to form the indicia. Other inclusions can be an LED (or other light source) and a battery power source; a hologram or lenticular artwork; an RFID computer chip or tag; a mirror; one or more gems or faux gems; etc. For example, another frictional pad as described above is shown with an LED electrically coupled to a battery. The LED may remain continuously activated or lit. Alternatively, the LED may be activated, or the leads for the LED selectively contacted by the battery, such as by pressure applied to the pad. Alternatively, a light sensor can be electrically coupled between the battery and the LED to activate the LED in low light conditions. Other electronics can be included for special effects, such as flashing, etc. It will be appreciated that multiple lights or LEDs of one or more color can be included or embedded in the dome. As another example, another frictional pad as described above is shown with a gem or faux gem embedded in the dome. The inclusion(s) can be disposed on the adhesive film and/or substrate, and surrounded by the material of the dome so that the inclusion projects into the dome. Thus, the inclusions can be inclusions for the dome and/or the graphics layer.

The dome can also include inclusions embedded therein. For example, the dome can include a scented material, such as a scented oil, that is permeable through the polyurethane material of the dome. In addition, the dome can be colored and translucent. Furthermore, the dome can include a florescent material.

In another aspect, the polyurethane layer or dome can be opaque with a graphic layer, such as printing, on the outfacing surface.

In another aspect, the indicia can be printed on or molded into the dome itself, such as on the top or front thereof.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A mobile, releasably attachable, white-board device, comprising:
a) a pad having opposite inner and outer surfaces, and being formed of polyurethane having a composition of polymer and catalyst to impart a tacky character to at least the inner surface so that the inner surface is capable of removable tacky attachment to a support surface without additional adhesive;
b) a primary indentation in the outer surface of the pad circumscribed by a perimeter rib;
c) a dry-erase sheet affixed to the pad in the primary indentation of the outer surface and circumscribed by the perimeter rib;
d) an outermost surface of the dry-erase sheet being substantially flush with an outermost surface of the perimeter rib;
e) the primary indentation and the dry-erase sheet occupying a majority of the surface area of the pad; and
f) a dry-erase marker removable coupled to the pad and being removable from the pad to write on the dry-erase sheet.

2. The device in accordance with claim 1, further comprising:
a) a pair of raised ribs extending from the outer surface of the pad and defining a channel therebetween;
b) the dry-erase marker removable disposed in the channel; and
c) the dry-erase marker having a diameter greater than a width of the channel, and the pair of raised ribs being flexible and resilient to grip the marker when disposed therein.

3. The device in accordance with claim 1, further comprising:
a) a secondary recess in the outer surface of the pad and located laterally adjacent to the primary indentation; and
b) a polyurethane dome affixed in the secondary recess.

4. The device in accordance with claim 3, wherein the polyurethane dome has a continuous outward facing surface with a majority being continuous, smooth and parallel with the pad.

5. The device in accordance with claim 3, wherein the polyurethane dome extends higher than the perimeter rib.

6. The device in accordance with claim 3, further comprising:
an adhesive film adhering the polyurethane dome to an outward facing surface of the secondary recess.

7. The device in accordance with claim 3, wherein the polyurethane dome is translucent or transparent; and further comprising a graphic layer disposed between the pad and the polyurethane dome, and visible through the polyurethane layer.

8. The device in accordance with claim 7, further comprising:
a substrate with an adhesive film on one side and the graphic layer printed on the other side.

9. The device in accordance with claim 3, wherein an outfacing surface of the polyurethane dome is tacky; and wherein the polyurethane dome is formed by polyol and catalyst in a ratio of between 0.85 to 0.95; and wherein the inner surface of the pad is formed by polyol and catalyst in a ratio of between 1 to 0.36.

10. The device in accordance with claim 3, wherein the polyurethane dome has a hardness between 10 and 35 Shore D.

11. The device in accordance with claim 3, wherein an outfacing surface of the polyurethane dome has a coefficient of friction of between 0.3 and 0.1 in accordance with ASTM D 1894.

12. The device in accordance with claim 1, further comprising:
a) a secondary recess in the outer surface of the pad and located laterally adjacent to the primary indentation; and
b) indicia indicative of or representing a business, a product, or both, disposed on an outward facing surface of the secondary recess.

13. A method for using the device in accordance with claim 1, comprising:
a) placing the pad against a first support surface with the inner surface of the pad removably attached to the first support surface;
b) removing the dry-erase marker from the pad;
c) writing on the dry-erase sheet with the dry-erase marker defining writing;
d) re-coupling the dry-erase marker to the pad;
e) removing the pad from the first support surface;
f) placing the pad against a second support surface, different than the first support surface, with the inner surface of the pad removably attached to the second support surface; and
g) erasing the writing on the dry-erase sheet.

14. A mobile, releasably attachable, white-board device, comprising:
a) a pad having opposite inner and outer surfaces, and being formed of polyurethane having a composition of polymer and catalyst to impart a tacky character to at least the inner surface so that the inner surface is capable of removable tacky attachment to a support surface without additional adhesive; and
b) a dry-erase sheet affixed to the pad.

15. The device in accordance with claim 14, further comprising:
a) a primary indentation in the outer surface of the pad circumscribed by a perimeter rib;
b) the dry-erase sheet being disposed in the primary indentation;
c) an outermost surface of the dry-erase sheet being substantially flush with an outermost surface of the perimeter rib; and
d) the primary indentation and the dry-erase sheet occupying a majority of the surface area of the pad.

16. The device in accordance with claim 14, further comprising:
a) a pair of raised ribs extending from the outer surface of the pad and defining a channel therebetween;
b) a dry-erase marker removable disposed in the channel; and
c) the dry-erase marker having a diameter greater than a width of the channel, and the pair of raised ribs being flexible and resilient to grip the marker when disposed therein.

17. The device in accordance with claim 14, further comprising:
a) a secondary recess in the outer surface of the pad and located laterally adjacent to the primary indentation; and
b) a polyurethane dome affixed in the secondary recess.

18. A method for using the device in accordance with claim 14, comprising:
a) placing the pad against a first support surface with the inner surface of the pad removably attached to the first support surface;
b) writing on the dry-erase sheet with a dry-erase marker defining writing;
c) removing the pad from the first support surface;
d) placing the pad against a second support surface, different than the first support surface, with the inner surface of the pad removably attached to the second support surface; and
e) erasing the writing on the dry-erase sheet.

19. A mobile, releasably attachable, white-board device, comprising:
a) a pad having opposite inner and outer surfaces, and being formed of polyurethane having a composition of polymer and catalyst to impart a tacky character to at least the inner surface so that the inner surface is capable of removable tacky attachment to a support surface without additional adhesive;
b) a primary indentation in the outer surface of the pad circumscribed by a perimeter rib;
c) a dry-erase sheet affixed to the pad in the primary indentation of the outer surface and circumscribed by the perimeter rib;
d) an outermost surface of the dry-erase sheet being substantially flush with an outermost surface of the perimeter rib;
e) the primary indentation and the dry-erase sheet occupying a majority of the surface area of the pad;
f) a dry-erase marker removable coupled to the pad and being removable from the pad to write on the dry-erase sheet;
g) a pair of raised ribs extending from the outer surface of the pad and defining a channel therebetween;
h) the dry-erase marker removable disposed in the channel;
i) the dry-erase marker having a diameter greater than a width of the channel, and the pair of raised ribs being flexible and resilient to grip the marker when disposed therein;
j) a secondary recess in the outer surface of the pad and located laterally adjacent to the primary indentation; and
k) a polyurethane dome affixed in the secondary recess.

20. A method for using the device in accordance with claim 19, comprising:
a) placing the pad against a first support surface with the inner surface of the pad removably attached to the first support surface;
b) removing the dry-erase marker from the pad;
c) writing on the dry-erase sheet with the dry-erase marker defining writing;
d) re-coupling the dry-erase marker to the pad;
e) removing the pad from the first support surface;
f) placing the pad against a second support surface, different than the first support surface, with the inner surface of the pad removably attached to the second support surface; and
g) erasing the writing on the dry-erase sheet.
